(19) United States
(12) Patent Application Publication
(10) Pub. No.: US 2011/0066412 A1
(43) Pub. Date: Mar. 17, 2011

(54) SYSTEM AND METHOD FOR PROCESSING APPLICATION LOGIC OF A VIRTUAL AND A REAL-WORLD AMBIENT INTELLIGENCE ENVIRONMENT

(75) Inventors: Markus Gerardus Leonardus Maria Van Doorn, S-Hertogenbosch (NL); Evert Jan Van Loenen, Waalre (NL)

(73) Assignee: KONINKLIJKE PHILIPS ELECTRONICS N.V., EINDHOVEN (NL)

(21) Appl. No.: 12/990,804

(22) PCT Filed: Apr. 30, 2009
(86) PCT No.: PCT/IB2009/051754

§ 371 Date: Nov. 3, 2010

(30) Foreign Application Priority Data
May 9, 2008 (EP) 08103879.6

(51) Int. Cl. G06G 7/48

(52) U.S. Cl. 703/3

(57) ABSTRACT

The invention relates to the processing of application logic of a virtual and a real-world ambient intelligence environment. An embodiment of the invention provides a system (10) for processing application logic (12) of a virtual and a real-world ambient intelligence environment, wherein the virtual ambient intelligence environment is a computer generated simulation of the real-world ambient intelligence environment and—the application logic defines at least one interactive scene in the virtual and the real-world ambient intelligence environment. The system comprises—a database (14) containing a computer executable reference model (16), which represents both the virtual and the real-world ambient intelligence environment and contains the application logic, —a translation processor (18) being adapted for translating the output of at least one sensor (20) of the virtual and real-world ambient intelligence environment into the reference model, and—an ambient creation engine (22) being adapted for processing the application logic of the reference model and controlling the rendering of the virtual and real-world ambient intelligence environment in accordance with the translated output of the at least one sensor of the virtual and real-world ambient intelligence environment.

### FIELD OF THE INVENTION

The invention relates to the processing of application logic of a virtual and a real-world ambient intelligence environment.

### BACKGROUND OF THE INVENTION

Ambient intelligence environments such as complex light and ambience systems are examples for real-world environments, which comprise application logic for providing an ambient intelligence. The application logic enables such environments to automatically react to the presence of people and objects in real space, for example to control the lighting depending on the presence of people in a room and their user-preferences. Future systems will allow customization of the ambient intelligence by end-users, for example by breaking up ambient intelligence-type of environments in smaller modular parts that can be assembled by end-users. By interacting with so-called ambient narratives, end-users may then create their own personal story, their own ambient intelligence from a large number of possibilities defined by an experience designer in advance. Although, this method allows individual end-users to create their own ambient intelligence, the customization is still limited because end-users follow pre-defined paths when creating their own ambient intelligence. The end-users are only seen as readers and not as writers in these systems. To allow end-users to program their own ambient intelligence environment, a method is needed that enables end-users to create their (own) fragments (beats) and add these beats to the ambient narrative in a very intuitive way.

The programming of an ambient intelligence environment is typically performed in a simulation of the real environment, i.e. in a virtual environment. This allows end-users to quickly compose and test for ambient scenes, such as interactive lighting scenes or effects, without having to physically experience them in a real world environment. However, the virtually modeled environment is never exactly the same as the real environment, so usually an adaptation of the application logic, which was designed for creating the user-desired effects or scenes in the virtual environment during the simulation, to the real world is required. However, the adaptation is for many end-users too complex and also a tedious task.

### SUMMARY OF THE INVENTION

It is an object of the present invention to provide a system and method, which do not require the adaptation of an application logic, programmed in a virtual ambient intelligence environment.

The object is solved by the independent claims. Further embodiments are shown by the dependent claims.

A basic idea of this invention is to provide application logic, which can be processed in both the virtual and the real-world ambient intelligence environment, by ensuring that the output of sensors and the input of actuators in the ambient intelligence environment are the same for the virtual and the real-world environment. Thus, application logic, which was modeled in the virtual ambient intelligence environment, does not have to be adapted to the real-world ambient intelligence environment.

An embodiment of the invention provides a system for processing application logic of a virtual and a real-world ambient intelligence environment, wherein
the virtual ambient intelligence environment is a computer generated simulation of the real-world ambient intelligence environment and
the application logic defines at least one interactive scene in the virtual and the real-world ambient intelligence environment,

wherein the system comprises
a database containing a computer executable reference model, which represents both the virtual and the real-world ambient intelligence environment and contains the application logic,
a translation processor being adapted for translating the output of at least one sensor of the virtual and real-world ambient intelligence environment into the reference model, and
an ambient creation engine being adapted for processing the application logic of the reference model and controlling the rendering of the virtual and real-world ambient intelligence environment in accordance with the translated output of the at least one sensor of the virtual and real-world ambient intelligence environment.

According to this embodiment, the application logic is used by both environments, and outputs from sensors of both environments are translated into the reference model in order to accomplish that the sensor outputs are the same for both environments.

In a further embodiment of the invention,
the application logic may comprise at least one event handler being adapted for processing the translated output of at least one sensor of the virtual and real-world ambient intelligence environment and controlling at least one actuator of the virtual and real-world ambient intelligence environment depending on the processing of the translated output of the at least one sensor, and
the ambient creation engine may be adapted for determining which event handler of the application logic must be activated depending on the output of one or more sensors of the virtual and real-world ambient intelligence environment.

An event handler of the application logic implements a certain functionality of the environment and may be programmed by an end-user, who desires a certain functionality or wants to create her/his own fragment of the ambient narrative underlying the ambient intelligence environment.

An event handler of the application logic may according to a further embodiment of the invention comprise
an action part being adapted for controlling the at least one actuator of the virtual and real-world ambient intelligence environment and
a preconditions part being adapted for controlling the action part depending on the translated output of the at least one sensor.

This separation of an event handler into two parts allows to better adapt the event handler to certain user requirements. For example, a user, who wishes to change only a certain functionality of the ambient, can alter the conditions for activating the functionality and also the functionality to be performed itself by changing the preconditions part and the action part, respectively.

The system may according to a further embodiment of the invention comprise an authoring tool being adapted for modeling application logic in the virtual ambient intelligence environment.

The authoring tool allows an end-user to easily create new application logic and to quickly simulate it in the virtual ambient intelligence environment, thus, not requiring to change the real-world ambient intelligence environment.

Furthermore, in an embodiment of the invention, the system may comprise a rendering platform being adapted for rendering the virtual and the real-world ambient intelligence environment by controlling at least one actuator of the virtual and real-world ambient intelligence environment depending on the processing of the translated output of the at least one sensor.

The rendering platform particularly serves as a further control layer for the actuators. The rendering platform is able to control actuators of both environments.

Particularly, the rendering platform may be adapted to control an actuator by transmitting an instruction to the actuator about an action to do, according to an embodiment of the invention.

The instruction may be an abstract command for the actuator such as “change hue of lighting to a warmer hue” or “display photo x on electronic display y”. The actuators themselves are in control how to do the instructed function, i.e. how to setup the lighting for a warmer hue or how to load photo x and to transmit it to display y. Thus, the rendering platform does not have to know specific implementation details and functions of the single actuators, but only which actuators are available and how to instruct them in order to activate a desired function.

The output of the at least one sensor of the virtual and real-world ambient intelligence environment may represent in an embodiment of the invention coordinates of an object in the virtual and real-world ambient intelligence environment, respectively.

In such case, sensors are a kind of position detection means. This is useful when interactive scenes of an environment should be activated depending on the presence and position of people, for example in a shop, when people stand before a shelf with special offers which should be highlighted in the shop in order to attract the attention of shoppers.

The invention provides in a further embodiment an ambient intelligence environment comprising
at least one sensor for detecting the presence of objects in the environment,
at least one actuator for performing an interactive scene in the environment, and
a system for processing application logic of a virtual and a real-world ambient intelligence environment according to the invention and as described before, being provided for users to create and model their own application logic and to implement the user's application logic in the ambient intelligence environment.

The environment may be in an embodiment of the invention an intelligent shop window environment and may comprise
presence detection sensors, and
light units and electronic displays as actuators.

This window allows to attract shopper's attention better than traditional shop windows, and can for example give more information to shoppers by displaying context information, for example when a shopper looks at a certain good, the window may automatically display information on this good on an electronic display, or it may switch on a spotlight highlighting the good in order to present more details of the good to the shopper.

Furthermore, an embodiment of the invention relates to a method for processing application logic of a virtual and a real-world ambient intelligence environment, wherein
the virtual ambient intelligence environment is a computer generated simulation of the real-world ambient intelligence environment and
the application logic defines at least one interactive scene in the virtual and the real-world ambient intelligence environment,

wherein the method comprises the steps of
providing a computer executable reference model, which represents both the virtual and the real-world ambient intelligence environment and contains the application logic,
translating the output of at least one sensor of the virtual and real-world ambient intelligence environment into the reference model, and
processing the application logic of the reference model and controlling the rendering of the virtual and real-world ambient intelligence environment in accordance with the translated output of the at least one sensor of the virtual and real-world ambient intelligence environment.

Such a method may be for example implemented by an algorithm which may be integrated in a central environment control unit, for example the control of a complex lighting environment or system in a shop or museum.

According to a further embodiment of the invention, the method may be adapted for implementation in a system according to the invention and as described above.

According to a further embodiment of the invention, a computer program may be provided, which is enabled to carry out the above method according to the invention when executed by a computer. Thus, the method according to the invention may be applied for example to existing ambient intelligence environments, particularly interactive lighting systems, which may be extended (or upgraded) with novel functionality and are adapted to execute computer programs, provided for example over a download connection or via a record carrier.

According to a further embodiment of the invention, a record carrier storing a computer program according to the invention may be provided, for example a CD-ROM, a DVD, a memory card, a diskette, or a similar data carrier suitable to store the computer program for electronic access.

Finally, an embodiment of the invention provides a computer programmed to perform a method according to the invention and comprising sound receiving means such as a microphone, connected to a sound card of the computer, and an interface for communication with an atmosphere creation system for creating an atmosphere. The computer may be for example a Personal Computer (PC) adapted to control a atmosphere creation system, to generate control signals in accordance with the automatically created atmosphere and to transmit the control signals over the interface to the atmosphere creation system.

These and other aspects of the invention will be apparent from and elucidated with reference to the embodiments described hereinafter.

The invention will be described in more detail hereinafter with reference to exemplary embodiments. However, the invention is not limited to these exemplary embodiments.

### BRIEF DESCRIPTION OF THE DRAWINGS

FIG. 1 shows a block diagram of an embodiment of a system for processing application logic of a virtual and a real-world ambient intelligence environment according to the invention; and

FIG. 2 shows a flow diagram of an embodiment of the processing of application logic of a virtual and a real-world ambient intelligence environment according to the invention.

### DETAILED DESCRIPTION OF EMBODIMENTS

In the following, functionally similar or identical elements may have the same reference numerals.

Ambient intelligence environments such as interactive lighting systems are able to generate interactive scenes such as lighting scenes by processing dedicated application logic, which implements the interactive scenes. The application logic may be modeled in a virtual representation of the real-world ambient intelligence environment. The virtual representation is a simulation of the real-world environment. In the simulation, real-world sensors and actuators are replaced by virtual counterparts in order to deliver inputs for the application logic and to simulate the behavior and functionality of the application logic and its control of the actuators.

A typical example of an ambient intelligence environment is an intelligent shop window environment, which is able to create lighting and display effects in the shop window depending on the presence of people standing in front of the window. This environment comprises presence detection sensors, an application logic for processing the outputs of the sensors and for controlling light units and electronic displays depending on the processed sensor outputs. The application logic implements the interactivity, i.e. which light units are to be activated depending on the position and movement of people in front of the window and which photos are to be displayed by the electronic displays.

In order to allow a customization of an ambient intelligence environment, end-users may use computer programs to program their own ambient intelligence environment by designing their own application logic. This can be done by breaking up ambient intelligence-type of environments in smaller modular parts that can be assembled by end-users. By interacting with so-called ambient narratives, end-users can create their own personal story, their own ambient intelligence from a large number of possibilities defined by an experience designer in advance. Although this method allows individual end-users to create their own ambient intelligence, the customization is still limited because end-users follow predefined paths. The end-users are only seen as readers and not as writers. To allow end-users to program their own ambient intelligent environment a method is needed that enables end-users to create their own fragments (beats) and add these beats to the ambient narrative in a very intuitive way, for example by enabling end-users to write their own beats using a graphical user interface.

The central component of such modular intelligent environments is a component (ambient narrative engine from now on) that determines which fragments must be activated given the current context of the user and his environment and the state of the intelligent environment. Each fragment basically consists of a preconditions part and an action part. The preconditions part states the context situation that must hold before the action can be executed. Essentially, each fragment can be seen an event handler description. When authors want to add new behavior to the intelligent environment they essentially write another event handler.

The application logic modeled and simulated by means of a virtual ambient intelligence environment should be applicable to both the virtual and the real-world ambient intelligence environment, in order to avoid a complex and costly adaptation of the application logic. In other words, it is desired to be able to port the application logic from the virtual to the real-world environment without requiring adaptation of the logic or to process it in both environments. According to the invention, this may be accomplished by ensuring that the sensor output and actuator input are the same for both the real-world and the virtual environment. In the virtual simulation, the real sensors are replaced by virtual sensors that for example detect the presence and identity of people (virtual characters) and send this information for further processing. Coordinates of objects in the real world and virtual world are translated into a reference model. At the output side, the actuators are instructed what action they must do (e.g. render a photo on a display). The actuators themselves are in control how they do this. This separation makes it possible to change the real actuators by virtual actuators without changing any code.

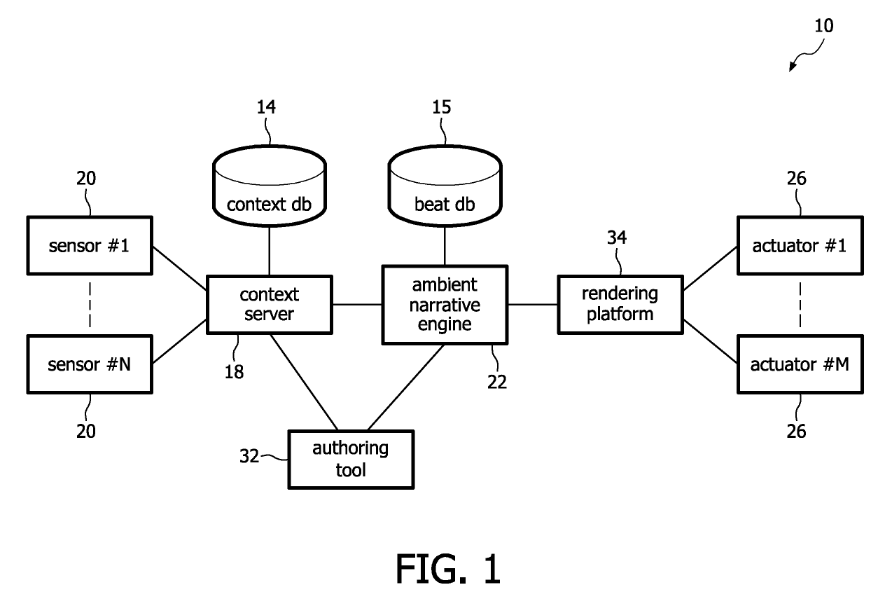

FIG. 1 shows the architecture of a system for processing application logic of a virtual and a real-world ambient intelligence environment. The system comprises as core elements
an ambient narrative engine 22, which is adapted to process an application logic of a reference model of the environment,
a rendering platform 34 for rendering an environment with desired interactive scenes in accordance with the application logic for both the real-world and the virtual environment, and
a context server 18 being adapted for translating the outputs of sensor 20 of the virtual and real-world ambient intelligence environment into the reference model.

The computer executable reference model represents both the virtual and the real-world ambient intelligence environment and contains the application logic and is stored in a database 14. A further database 15 stores the beats or fragments, which are executed by the ambient narrative engine to process the application logic of the reference model. An authoring tool 32, for example a computer program with a graphical user interface, allows end-users to program and simulate their own application logic.

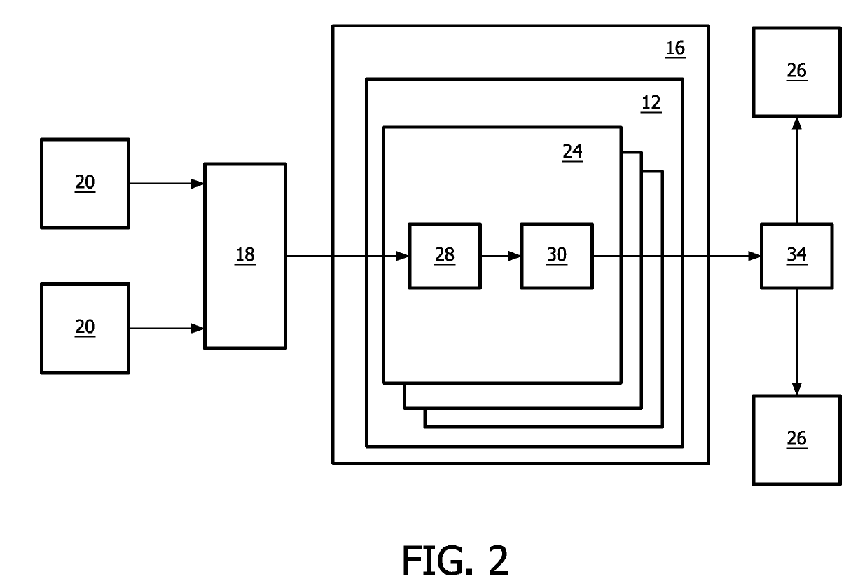

FIG. 2 shows the processing flow as performed in the system shown in FIG. 1. The outputs of the sensors, either virtual or real-world sensors 20 are translated by the context server 18, which executes the reference model 16 stored in the database 14. The reference model 16 contains the application logic 12 programmed by an end-user. The application logic 12 itself comprises event handlers 24, each being provided and programmed for controlling a certain actuator 26 depending on a certain sensor output, for example displaying a certain photo on an electronic display in the shopping window, when a person stands in front of the window at a certain time of day and at a certain temperature. For example, when a person stands in the early morning in front of the window, and the outside temperature is cold like during winter, the event handler can be programmed to process the outputs of a presence detection sensor and a temperature sensor to display a photo of a warm and sunny day on an electronic display in the shopping window and to adjust the color of light units illuminating the window to a warmer hue.

Each event handler 24 comprises a preconditions part 28 and an action part 30. The action part 30 is adapted for controlling one or more actuators 26 as instructed by the preconditions part 28, which is adapted for processing received sensor outputs in order to state the context situation that must hold before an action can be performed by the action part 30. In the before described example of the shopping window, the preconditions part 28 receives the outputs from the presence sensor and the temperature sensor and determines the context, i.e. presence of person detected, outside temperature is cold, time of day is early morning. Then the preconditions part 28 determines in accordance with the context that a photo of a warm and sunny day should be displayed on an electronic display in the shopping window and the color of light units illuminating the window should be adjusted to a warmer hue. The preconditions part 28 then instructs the action part 30 to signal to the rendering platform 34 to display the determined photo and to adjust the determined warmer hue of the illumination.

The rendering platform 34 then selects the suitable actuator(s) 26 to perform the action signaled by an event handler 24, or by its action part 30, and instructs the selected actuator(s) 26 accordingly. For example, the rendering platform selects suitable light units and instructs them to change their hue to a warmer hue, and it selects an electronic display and instructs it to display a photo of a warm and sunny day, loaded from a picture database, for example over a network such as the internet. The separation makes it possible to change the real-world actuators by virtual actuators without changing any code.

Typical applications of the invention are light and ambience control systems, and context-aware ambient Intelligence environments in general.

At least some of the functionality of the invention may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. System for processing application logic of a virtual and a real-world ambient intelligence environment, the virtual ambient intelligence environment being a computer-generated simulation of the real-world ambient intelligence environment, the system comprising
a database containing a computer executable reference model, which represents both the virtual and the real-world ambient intelligence environment and contains an application logic defining at least one interactive scene in the virtual and real world ambient intelligence environment,
a translation processor for translating the output of at least one sensor of the virtual and real-world ambient intelligence environment into the reference model, and
an ambient creation engine for processing the application logic of the reference model and controlling the rendering of the virtual and real-world ambient intelligence environment in accordance with the translated output of the at least one sensor of the virtual and real-world ambient intelligence environment.

2. The system of claim 1, wherein the application logic comprises at least one event handler for processing the translated output of at least one sensor of the virtual and real-world ambient intelligence environment and controlling at least one actuator of the virtual and real-world ambient intelligence environment depending on the processing of the translated output of the at least one sensor, and the ambient creation engine is adapted for determining which event handler of the application logic must be activated depending on the output of one or more sensors of the virtual and real-world ambient intelligence environment.

3. The system of claim 2, wherein an event handler of the application logic comprises
an action part for controlling the at least one actuator of the virtual and real-world ambient intelligence environment and
a preconditions part for controlling the action part depending on the translated output of the at least one sensor.

4. The system of claim 1, further comprising an authoring tool for modeling application logic in the virtual ambient intelligence environment.

5. The system of claim 1, further comprising a rendering platform for rendering the virtual and the real-world ambient intelligence environment by controlling at least one actuator of the virtual and real-world ambient intelligence environment depending on the processing of the translated output of the at least one sensor.

6. The system of claim 5, wherein the rendering platform is adapted to control an actuator by transmitting an instruction to the actuator about an action to do.

7. The system of claim 1, wherein the output of the at least one sensor of the virtual and real-world ambient intelligence environment represents coordinates of an object in the virtual and real-world ambient intelligence environment, respectively.

8. An ambient intelligence environment comprising
at least one sensor for detecting the presence of objects in the environment,
at least one actuator for performing an interactive scene in the environment, and
a system for processing application logic of a virtual and a real-world ambient intelligence environment of claim 1, being provided for users to create and model their own application logic and to implement the user's application logic in the ambient intelligence environment.

9. (canceled)

10. Method for processing application logic of a virtual and a real-world ambient intelligence environment, the virtual ambient intelligence environment being a computer generated simulation of the real-world ambient intelligence environment, the method comprising the steps of
providing a computer executable reference model, which represents both the virtual and the real-world ambient intelligence environment and contains an application logic, the application logic defining at least one interactive scene in the virtual and the real-world ambient intelligence environment,
translating the output of at least one sensor of the virtual and real-world ambient intelligence environment into the reference model, and
processing the application logic of the reference model and controlling the rendering of the virtual and real-world ambient intelligence environment in accordance with the translated output of the at least one sensor of the virtual and real-world ambient intelligence environment.

11. (canceled)

12. A computer program enabled to carry out the method according to claim 10 when executed by a computer.

13. A record carrier storing a computer program according to claim 12.

14. (canceled)
